(19) United States
(12) Patent Application Publication
(10) Pub. No.: US 2022/0397690 A1
(43) Pub. Date: Dec. 15, 2022

(54) Detection and Removal of Delayed Seismic Travel Times Produced by Velocity Inversions

(71) Applicant: Saudi Arabian Oil Company, Dhahran (SA)

(72) Inventors: Daniele Colombo, Dhahran (SA); Apostolos Kontakis, Delft (NL); Ernesto Sandoval-Curiel, Dhahran (SA); Diego Rovetta, Delft (NL)

(21) Appl. No.: 17/776,660

(22) PCT Filed: Nov. 27, 2019
(86) PCT No.: PCT/IB2019/060248

§ 371 Date: May 13, 2022

(51) Int. Cl. G01V 1/36; G01V 1/30; G01V 1/34

(52) U.S. Cl. CPC G01V 1/362; G01V 1/305; G01V 1/345; G01V 2210/67; G01V 2210/53

(57) ABSTRACT

In seismic imaging, accurate velocity functions (velocity model) defining seismic velocity as a function of depth in the earth are required. The velocity model is obtained as a result of seismic surveying. Delayed travel times in near surface refraction seismic surveys, an effect known as shingling, can result from an anomalous condition, seismic velocity decreasing with depth. Inclusion of such delayed travel times in a tomographic process for seismic imaging would otherwise cause large errors in determination of a seismic velocity model for seismic imaging of subsurface features. At locations (source-receiver offset) in the survey where the shingling occurs, the velocity inversions are identified. The undesirable effects the delayed travel times caused by the velocity inversions are removed from the survey dataset.

### CROSS REFERENCE TO RELATED APPLICATIONS

This application claims the benefit and priority of PCT/IB2019/060248, filed on Nov. 27, 2019, entitled “DETECTION AND REMOVAL OF DELAYED SEISMIC TRAVEL TIMES PRODUCED BY VELOCITY INVERSIONS” which is hereby incorporated by reference in its entirety to this application.

### BACKGROUND OF THE INVENTION

### 2. Field of the Invention

The present invention relates to geophysical exploration, and more particularly to seismic exploration of low-relief structures and stratigraphic traps. More specifically, the present invention involves processing of seismic survey data for detection and removal of delayed seismic travel times in the seismic survey results produced by the seismic velocity inversions.

### 3. Description of the Related Art

Seismic velocity modeling in the presence of layered earth with alternating subsurface formation layers of high and low velocity has presented significant problems. The data that are used in production for estimating the speed of seismic phases such as the compressional body wave or pressure wave (P-wave) are the travel times of first wave arrivals. The P-wave arrivals are generated by refracted waves that travel at higher speed in the deep subsurface allowing the wave to arrive at geophones at longer offset or distance before the arrival of the slower wave that propagates along the direct path from the source to the receiver. The P-wave travel times are utilized to infer the subsurface velocity structure by a computerized process known as inversion performed on the travel times recorded at increasing source-receiver offsets from the source location.

The inversion processing relies on an assumption that the seismic velocity increases with depth. However, in certain geologic scenarios this is not the case. Where there are high velocity rocks (such as carbonates, basalts, and permafrost) either outcropping or alternating with low velocity rocks (shales, unconsolidated clastics, and the like), the seismic velocity profile undergoes a decrease with depth before it again increases. Such a phenomenon is known in seismic exploration and is called “velocity inversion.”

Velocity inversions represent a major problem for refraction seismology and for inversion methods that use seismic velocity data to infer the velocity structure as a function of depth. The problem of velocity inversion has been referred to in refraction seismology as a “hidden layer” because the velocity inversion represents a non-refractive geologic layer which has no velocity signature in the data. When a refracted wave impinges a lower velocity formation, the wave is deflected downward according to the Snell's Law. The geologic layer representing a velocity inversion cannot produce a corresponding upward refraction and, as such, it does not appear as a velocity signature in the P-wave arrivals. The velocity signature is the slope of the travel time arrivals versus offset representing the “apparent velocity”.

In many cases, a velocity signature in conditions of velocity inversions or a hidden layer exhibits a gap or a delay in lateral continuity of travel time curves representing the emergence of the refracted arrivals of deeper formations. In the context of the present invention, the effect of velocity inversions or a hidden layer is referred to in the literature as “shingling”. Examples of references to shingling in the literature are Sun, M., and J. Zhang, and Y. Wang, 2018, “Recognizing Shingling Seismic Data by Unsupervised Machine Learning”, SEG Technical Program, 2561-2565, and Sun, M., and J. Zhang, 2013. “Understanding of the First Arrivals in the Shape of A Christmas Tree”, SEG Technical Program, 1843-1846.

It is very important that first break travel times representing the effect of shingling or, in other words, the hidden layers or velocity inversions, do not enter the tomographic process. If the effect of shingling is present in the tomographic process, the consequence are generating wrong velocity models and compromise of the seismic imaging process with risks of incorrect placement of wells during exploration drilling. This problem is known. In some situations random quality control (QC) has been performed in an attempt to remove shingled travel times from the first break travel time dataset before tomographic inversion.

The volume of seismic trace data obtained by current seismic exploration campaigns is typically in the order of billions of traces. The sheer volume of the data to be processed has made any attempt to perform interactive QC inefficient and time consuming.

### SUMMARY OF THE INVENTION

Briefly, the present invention provides a new and improved method of detecting and removing effects of seismic velocity inversions in near surface earth layers from seismic survey data in the form of a set of seismic survey traces obtained from records of seismic energy travel from seismic sources to an array of seismic detector geophones during a seismic survey. The method is performed in a computer which has a memory and a processor.

According to the method of the present invention, refraction seismic survey data is obtained from the seismic survey. A first break dataset is then obtained from the refraction seismic survey data. Computer operable instructions stored the memory of the data processing system cause the computer to process the obtained first break data set to detect and remove effects of seismic velocity inversions in near surface earth layers from the seismic survey data.

The processor, under control of the stored computer operable instructions, detects and removes effects of the seismic velocity inversions by forming a measure of travel times of the seismic traces of the first break dataset as a function of offset of the detector geophones from the seismic sources. The processor then determines a measure of travel time at individual offset locations in the seismic survey and determines a measure of rate of travel of the seismic energy at the individual offset locations.

The processor then removes from the first break dataset seismic traces at the individual offset locations indicating the presence of seismic velocity inversions based on the determined measure of the rate of travel of the seismic energy to form a corrected first break dataset. A seismic velocity model of seismic velocity as a function of depth the subsurface formation based on the corrected first break data set is formed by the processor, and an image of the subsurface strata is formed by performing a tomographic inversion on the corrected first break dataset.

The present invention also provides a new and improved data processing system for detecting and removing effects of seismic velocity inversions in near surface earth layers from seismic survey data. The seismic survey data is in the form of a set of seismic survey traces obtained from records of seismic energy travel from seismic sources to an array of seismic detector geophones during a seismic survey. The data processing system includes a memory storing computer operable instructions causing the data processing system to detect and remove the effects of the seismic velocity inversions in the near surface earth layers from seismic survey data.

The data processing system also includes a processor performing under control of the computer operable instructions stored in the memory a sequence of processing steps. The processing steps include forming a measure of travel times of the seismic traces of the first break dataset as a function of offset of the detector geophones from the seismic sources. Next the processor determines a measure of travel time at individual offset locations in the seismic survey. The processor then determines a measure of rate of travel of the seismic energy at the individual offset locations

Traces from the first break dataset seismic traces indicating the presence of seismic velocity inversions at the individual offset locations are removed by the processor based on the determined measure of the rate of travel of the seismic energy to form a corrected first break dataset. The processor then forms a seismic velocity model of seismic velocity as a function of depth in the subsurface formation based on the corrected first break data set, and forms an image of the subsurface strata by performing a tomographic inversion on the corrected first break dataset. The memory of the data processing system further receives for storage the formed model of seismic velocity as a function of depth in the subsurface formation based on the corrected first break data set.

The present invention provides a new and improved data storage device which has stored in a non-transitory computer readable medium computer operable instructions for causing a data processing system to detect and remove effects of seismic velocity inversions in near surface earth layers from seismic survey data in the form of a set of seismic survey traces obtained from records of seismic energy travel from seismic sources to an array of seismic detector geophones during a seismic survey. The data processing system has a memory and a processor.

The instructions stored in the data storage device causing the data processing system to perform a sequence of processing steps, including storing in the memory computer operable instructions causing the data processing system to detect and remove effects of seismic velocity inversions in near surface earth layers from seismic survey data.

The instructions cause the processor, under control of the stored computer operable instructions, to perform steps to detect and remove effects of seismic velocity inversions in near surface earth layers, which include determining a measure of travel times of the seismic traces of the first break dataset as a function of offset of the detector geophones from the seismic sources and forming a measure of travel time at individual offset locations in the seismic survey.

The stored instructions next cause the processor to determine a measure of rate of travel of the seismic energy at the individual offset locations, and then remove from the first break dataset seismic traces at the individual offset locations indicating the presence of seismic velocity inversions based on the determined measure of the rate of travel of the seismic energy to form a corrected first break dataset.

The stored instructions then cause the processor to form a seismic velocity model of seismic velocity as a function of depth in the subsurface formation based on the corrected first break data set, and forming an image of the subsurface strata by performing a tomographic inversion on the corrected first break dataset.

### BRIEF DESCRIPTION OF THE DRAWINGS

The present application contains drawings executed in color. It is submitted that the color drawings are necessary to gain a more thorough understanding of the advantages and benefits of the present invention. As disclosed in the enclosed application, the present invention relates to geophysical exploration, and more particularly to seismic exploration of low-relief structures and stratigraphic traps. The color drawings obtained are important in illustrating the presence of undesirable anomalous seismic velocities in subsurface structure under certain stratigraphic conditions. Applicants submit that the enclosed color figures submitted with the application are the only practicable medium for illustrating these features of the claimed embodiments of the invention.

FIG. 1A is a schematic diagram illustrating travel of reflected wave seismic energy through a near surface region of the earth during a seismic survey.

FIG. 1B is a schematic diagram illustrating travel of refracted wave seismic energy through a near surface region of the earth during a seismic survey.

FIG. 2 is display of a seismic gather displaying the effect of shingling in near surface refraction surveying.

FIG. 3A is a display of a synthetic model of near surface earth formations with typical seismic velocity conditions.

FIG. 3B is a display of the model of FIG. 3A after tomographic inversion of synthetic seismic survey results.

FIG. 4A is a display of a synthetic model of near surface earth formations with shingling present due to seismic velocity inversion.

FIG. 4B is a display of the model of FIG. 4A illustrating the effect of seismic velocity inversion on attempts at tomographic inversion of synthetic seismic survey results.

FIG. 5A is a plot of first break time as a function of offset distance in a seismic survey with typical seismic velocity conditions.

FIG. 5B is plot of seismic velocity as a function of depth based on the time-offset distribution of FIG. 4A.

FIG. 6 is a comparative plot illustrating the effect of shingling on cubic spline fits of first break time as a function of offset.

FIG. 7 is a functional block diagram of a flow chart of data processing steps according to the present invention for detection and removal of delayed seismic travel times produced by velocity inversions.

FIG. 8 is a plot of an example spline fitted for first break time as a function of offset distance in a seismic survey.

FIG. 9 is a plot of results obtained during processing according to the present invention.

FIG. 10 is a schematic diagram of a data processing system for detection and removal of delayed seismic travel times produced by velocity inversions according to the present invention.

### DETAILED DESCRIPTION OF THE PREFERRED EMBODIMENTS

Seismic Wave Travel During Seismic Surveys

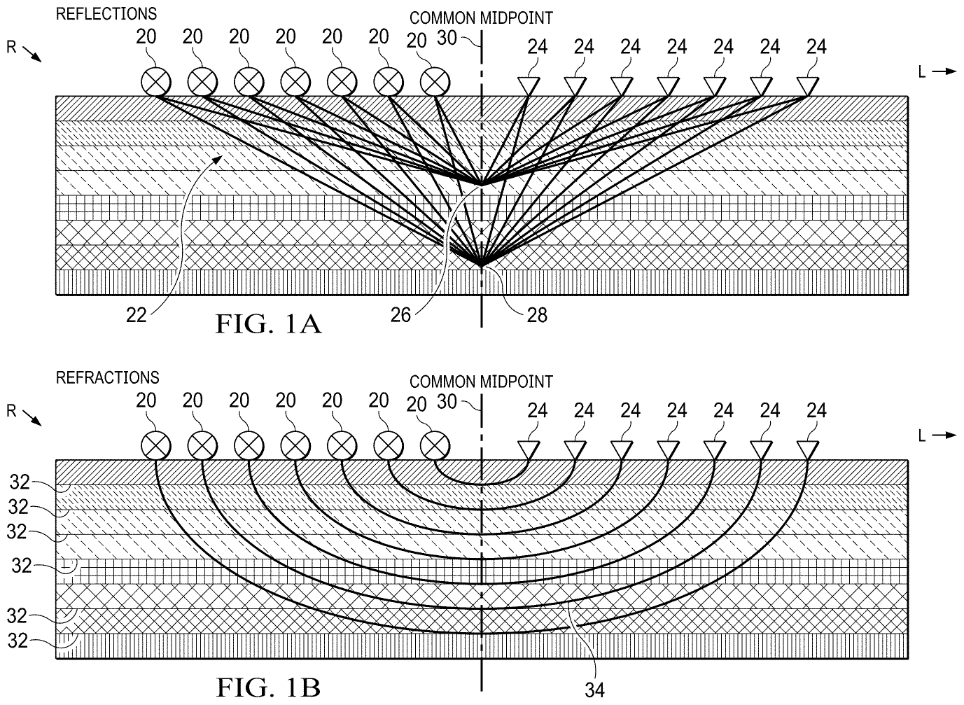

In the drawings, FIG. 1A illustrates schematically a plot of seismic wave travel resulting from the performance of a two-dimensional reflection seismic survey along a seismic line of profile along a longitudinal direction or line of profile L over a region R of the earth. The present invention is equally applicable to three-dimensional surveys or to two intersecting rectangular lines of profile as well.

As indicated schematically in FIG. 1A, seismic energy is imparted at a number of elastic wave sources or shot points 20 along the line of profile L for travel along travel paths 22 through a succession of subsurface formation layers for receipt at a number of detector geophones 24 along the line of profile. The detector geophones 24 serve as sensors or receivers of the seismic energy imparted by the sources 20.

Seismic energy from the sources travels as waves as indicated at 22 downwardly from the sources 20 through a number of subsurface layers at increasing depths in the earth. At each successive interface between adjacent layers, because of the differing acoustic velocity (that is, seismic impedance), a portion of the seismic energy is reflected as shown schematically at interfaces 26 and 28 as reflected waves and travels to the sensor geophones 24. The reflected energy sensed is then recorded and stored for seismic data processing to locate and identify subsurface of interest for the purpose of exploration and production of hydrocarbons. In such data processing, the energy sensed at particular groupings of sensors 24 are assembled as functions of a common time scale into what are known as seismic data gathers.

FIG. 1A illustrates schematically what is known as a common midpoint (CMP) gather. In the CMP gather of FIG. 1A, seismic data traces from a reflection seismic survey resulting from reflected wave energy imparted at each of a set of individual shot points 20 and received at associated sensors 24 are assembled for subsequent processing in accordance with the present invention. The individual shot points 20 and their associated receivers 24 in the CMP gather are equally spaced from each other on the earth surface from a common midpoint 30 equidistant between each source and receiver set or pair.

FIG. 1B illustrates schematically a plot of seismic wave travel resulting from the performance of a two-dimensional refraction seismic survey along a seismic line of profile along the longitudinal direction or line of profile L over the surface region R. As indicated schematically in FIG. 1B, seismic energy is imparted at the shot points 20 along the line of profile L for travel through the earth for receipt at the sensor or detector geophones 24 along the line of profile. The present invention is equally applicable to three-dimensional surveys or to two intersecting rectangular lines of profile, as well. The plots of FIGS. 1A and 1B are typically formed as a result of a single survey, with portions of the seismic energy from the shot points 20 travelling through the earth as reflected energy waves as shown in FIG. 1A and other portions of the seismic energy traveling as refracted energy waves as shown in FIG. 1B.

At each of a succession of increasingly deeper interfaces between subsurface formation layers, each identified by reference numeral 32, portions of the seismic energy from the sources 20 rather than being reflected as shown in FIG. 1A is refracted as shown in FIG. 1B at each of the interfaces 32. The refracted energy at an example one of the interfaces 32 travels along such interface as a refracted wave indicated at 34 for some distance as shown in FIG. 1B until the refracted wave energy travels upwardly to the detector geophones 24. Refracted waves travel along other interfaces between other layers as indicated in FIG. 1B. In the idealized model depicted in FIG. 1B (velocity increasing with depth), the offset is the main parameter controlling the depth of penetration of refracted waves 34.

Thus, as shown in FIGS. 1A and 1B, in seismic surveying when the earth is excited with energy from the elastic wave sources 20, the wave propagation are approximated and described by rays. Reflected waves such as at 22 and refracted waves such as at 34 are scattered at velocity interfaces such as 26, 28 and 32. The present invention utilizes this physical manifestation of seismic energy travel indicated schematically in FIGS. 1A and 1B for a methodology of automated near surface analysis by surface-consistent refraction, as will be described. The present invention involves the seismic data processing sequence and is performed to provide an iterative methodology implemented in computers for refinement of automated near surface analysis by surface-consistent refraction. The present invention is to a great extent automated and is based on robust statistics.

The common midpoint (CMP) sorting domain is assumed to represent the common subsurface structure. This assumption developed for reflected waves such as shown schematically in FIG. 1A, is also applicable to a surface-consistent representation of refracted waves, such as that shown schematically in FIG. 1B. Refracted waves are different, as shown in FIG. 1B, from reflection waves. For refracted waves, each source-receiver pair is spaced at different offset from each of the other source-receiver pairs, but shares the same common midpoint or CMP 30. The data obtained from processing refracted wave energy of the type shown schematically in FIG. 1B from each source-receiver pair provides information about a different part of the structure: a different depth and a different seismic velocity.

For refracted waves, an effective and concise representation of the subsurface structure is obtained from the binning in the CMP and offset domains by a process known as pQC. The process of binning in the CMP and offset domains is described in commonly owned U. S. Published Application No. 2017/0176617, which is incorporated herein by reference.

### Shingling Due to Seismic Velocity Inversion

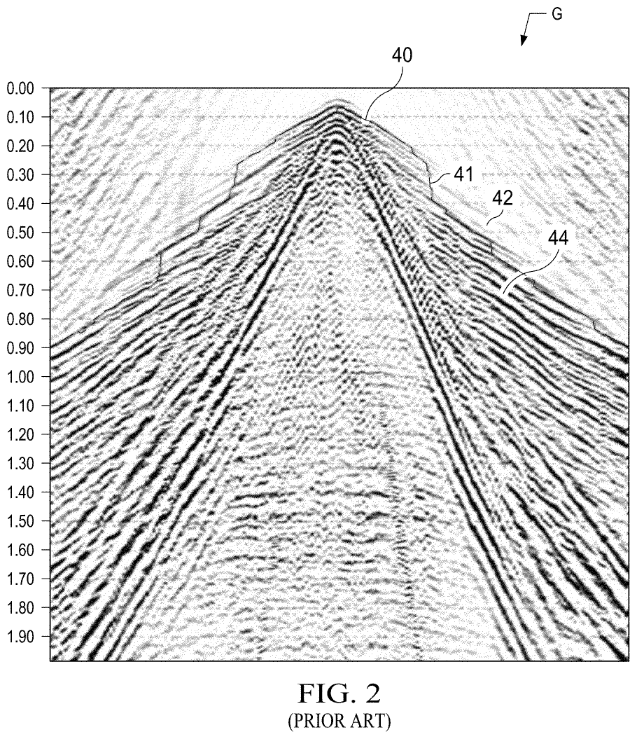

In FIG. 2, an example seismic gather G, which was obtained in geologic conditions of a seismic velocity, inversion is shown. The gather G can be seen to be affected by shingling as indicated by a travel time curve line 40 indicating first arrival times. The travel time curve 40 exhibits a stepping or shingled appearance in the lateral continuity of the refracted arrivals.

Travel time curve 40 indicates an incorrect picking of first arrivals as produced by a standard automatic picking algorithm. One notices the scaled behavior, sudden changes or jumps in the travel time curve 40 that instead should be linearly continuous. Unfortunately, because of the velocity inversions the amplitude of the correct first arrivals is progressively dimming with increasing offset such that the standard automatic first break picker starts picking later (and more energetic) arrivals interpreting them as “first arrivals”.

Virtually anything that happens to the travel time curve 40 after the jump identified by 41 is incorrect. As will be described, the present invention provides removal of these “false” data from the dataset. The present invention provides identification of the jumps indicated by 41 and removal of first break data occurring at offset larger than the first jump 41. The jump 41 as well as others incorrectly picked “first arrivals” and successive events are also removed from the dataset.

The operation of “first break picking” is a process by which an automatic “picking” computerized seismic processing functionality performs a scan of the recorded data to pick the travel time of the first arrival. When a seismic gather is affected by shingling as a result of decreasing seismic velocity with depth, first break picking methods have tended to pick as first arrivals the travel times which first appear as distinguishable seismic wave amplitudes. As a consequence the arrival times of delayed events have been consistently picked, as indicated by the travel time curve 40. That type of travel time information is misleading and causes large errors to be introduced by the process of inversion in the seismic velocity model. When such erroneous velocity models are used for the process of seismic imaging either in the time or the depth domains, the resultant errors in the velocity produce focusing of the migrated seismic energy at wrong depths. The erroneous velocity models can also cause the appearance of false structures that might affect later decisions regarding drilling locations in search of hydrocarbon resources.

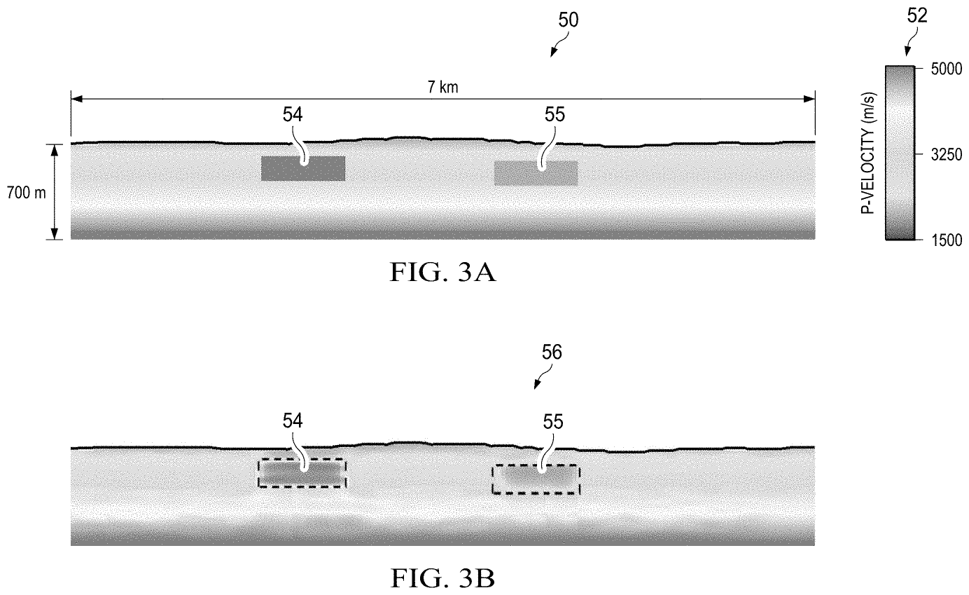

As an example, FIG. 3A is a simplified synthetic velocity model 50 along a seismic line of profile in the earth as a function of depth with background velocity increasing with depth. A quantifying color key 52 indicates the seismic velocity amplitude in the velocity model 50 in meters per second (m/s). A pair of anomalies are purposely included at 54 and 55 in the model 50. The synthetic model 50 was used to determine refracted travel times which were then subjected to tomographic inversion to reconstruct the synthetic velocity structure.

FIG. 3B is a tomographic model display 56 of the results of tomographic inversion based on the velocity model 50 shown in FIG. 3A. It can be seen in model 56 of FIG. 3B that the results of tomographic inversion recover and correctly represent the anomalies 54 and 55 of the velocity model 50. It can be noticed that when the background velocity is increasing with depth as shown in FIG. 3A, the tomographic model 56 (FIG. 3B) is correctly reconstructing the velocity structure.

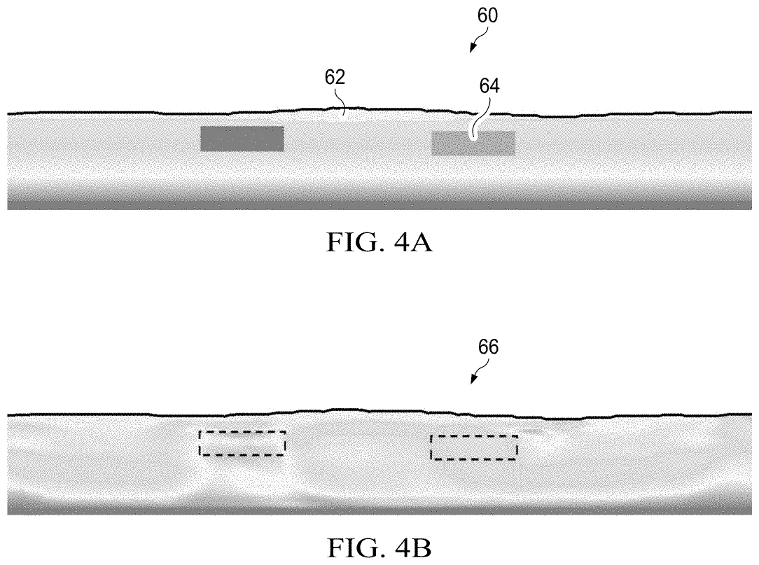

FIG. 4A is a model 60 of seismic velocity also according to the color key 52 of FIG. 3A. A velocity inversion in the form of a high velocity layer at the surface can be seen at 62 in upper portions of the seismic velocity model 60. An anomaly 64 is also intentionally introduced. The synthetic model 60 was also used to determine refracted travel times which were then processed by tomographic inversion.

FIG. 4B is a display 66 of the results of tomographic inversion based on the velocity model 60 shown in 4A. FIG. 4B clearly indicates that tomographic inversion of the velocity model 60 does not recover the correct velocity structure when a shallow velocity inversion such as that shown at 62 is present. With the high velocity layer 62 present at the surface (FIG. 4A), the tomographic reconstruction results in model 66 (FIG. 4B) are incorrect. The velocity 64 in the displays of FIG. 4B is visibly different in values of the velocities displayed. The anomaly 64 purposely present in the model 60 is not present in display 66. The background velocity model is also incorrectly reconstructed.

The present invention provides a methodology for identifying and removing shingled events from a seismic survey travel time dataset. The present invention also provides a qualitative quantification of errors involved in the seismic velocity modeling process.

The present application is of common ownership with and provides improvements to the methodologies according to U.S. Pat. No. 10,067,255, “Automatic Quality Control of Seismic Travel Time”, U. S. Published Application No. 2017/0176617, “Automated Near Surface Analysis by Surface-Consistent Refraction Methods”, and U. S. Published Application No. 2018/0321405, “Refraction-Based Surface-Consistent Amplitude Compensation and Deconvolution”. The methods described therein are referred to as “pQC.”

U.S. Pat. No. 10,067,255 is based on the sorting of large volumes of seismic first break arrivals into hypercubes. The hypercubes are formed for midpoints between seismic sources and receivers and with “offset” as a pseudodepth. The travel time data collected in such a hypercube is analyzed statistically for each bin (XYO bin: X-midpoint, Y-midpoint, offset) and outliers are eliminated. The resulting dataset is cleaned from the presence of outliers. This processing assumes Gaussian distribution of errors so that outliers can be readily identified by statistical processing and removed from the data.

In U. S. Published Application No. 2017/0176617, velocity-depth functions are obtained from the distribution of travel time-offset obtained from XYO (and Azimuth) sorting. Outlier removal is performed by the hypercube processing according to previously mentioned U.S. Pat. No. 10,067,255.

In particular, a constrained cubic spline is fitted to the travel time data in the XYO bins (that is, the same X-Y and variable offsets). The slope of the spline which is fitted represents the local (apparent) velocity that is integrated to obtain a velocity-depth profile at the XY midpoint position. The characteristics of such a cubic spline are that it is monotonic (velocity must increase with depth) and an allowed minimum/maximum slope is set. When the slope as a defined and set slope, the local velocity is bounded. The spline is then sampled by a piecewise linear function and the resulting linear segments are used to perform the velocity-depth transform.

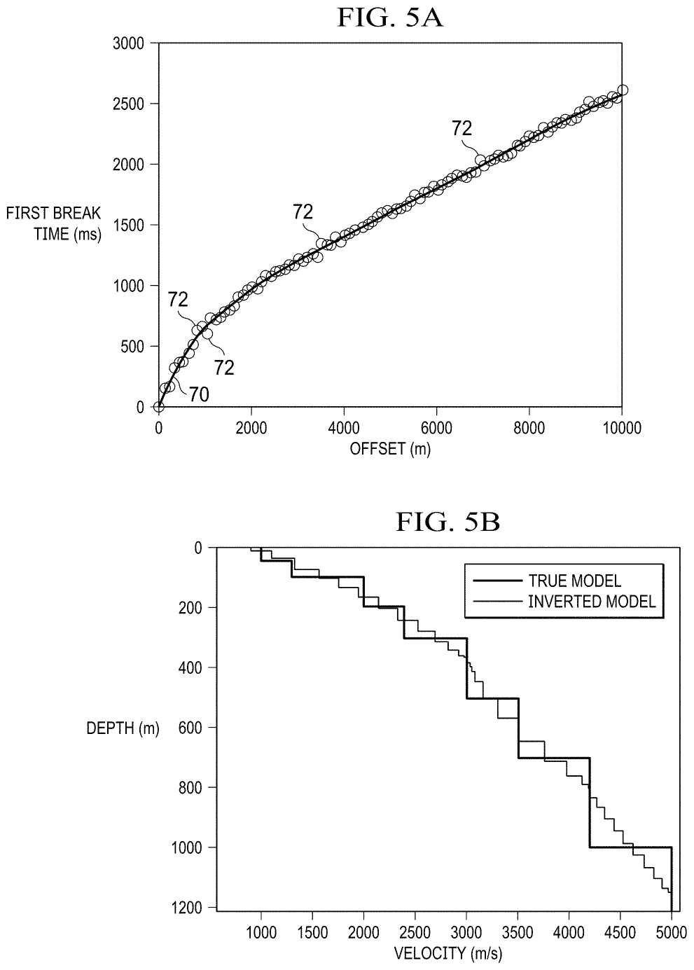

An example of this pQC process is provided in FIG. 5A. A reconstructed velocity model is illustrated by a velocity function spline 70 fitted to a set of seismic survey first break data times 72. The travel time function can be seen to be a good approximation of a true model indicated by data sample points. FIG. 5B is a comparative plot of seismic velocity as a function of depth for an actual velocity model and an inverted model as indicated by a legend in FIG. 5B. As can be observed, the inverted model is a good approximation of the true model.

However, with the present invention, as described in connection with FIGS. 3A, 3B, 4A, and 4B, it has been found that in the case of shingling in the travel times a velocity model obtained by the pQC method is not effective. The velocity results are biased by the delayed (shingled) travel times.

In some cases of pQC processing it has been noted that the travel time errors do not possess a Gaussian distribution. When shingling is present, for example, the delayed arrivals are consistently picked. As a result, the distribution can be bi-modal, or in some cases Gaussian. Moreover, it has been found that the statistical distribution is systematically biased by the shingling effect. In such cases the statistical rejection in the XYO bin does not produce meaningful results and the results of processed dataset remains biased by the shingled arrival times.

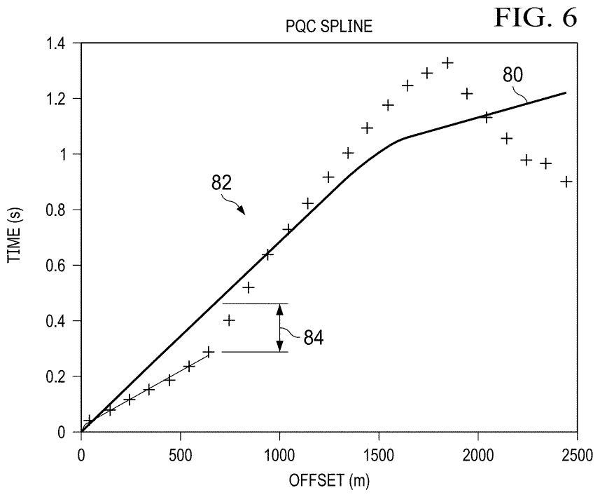

FIG. 6 is a plot of travel times as a function of offset in the presence of shingling for first break data indicated by + signs at the data points, as well as a fitted travel time function 80. The travel time function 80 is in the form of a monotonically-increasing constrained fitting spline formed during pQC. The undesirable effect of shingled arrival times on the constrained cubic spline is evident. As indicated at 82 a large mismatch or residual travel time is present between the first break data and the fitted travel time function 80. The velocity derived from the spline fitting for the shingled arrivals is not representative of the real geology. The residual between the spline and the travel time data is large. An example of fitting first break data with shingling detection for segment of data points is shown at 84.

FIG. 6 also demonstrates that the shingled travel times produce a poor fit of the monotonically-increasing constrained cubic spline. If such a velocity function were to be used, large errors would be incorporated into seismic imaging process. As has been noted, the seismic imaging process strongly depends on accurately determined seismic velocities.

### Detection and Removal of Shingled Events in Seismic Traces

The present invention provides a methodology for automatically detecting and eliminating shingled travel times, and at the same time for mapping the residuals produced by the spline fitting process. With shingling detection according to the present invention, the spline function is fitted before the shingling happens at a certain offset.

The spline fitting may be performed for each offset (volume in XYO domain of the misfit between observed and spline interpolated travel times). The spline fitting according to the present invention may alternatively be performed as an average RMS (root mean square) value mapped in the XY domain of the RMS of the misfit between observed and spline interpolated travel times. The fitting spline is used as a quality indicator of the reliability of the velocity model determination. Another parameter provided according to the present invention is a map (XY domain) of maximum acceptable or valid offsets utilized for the velocity model building. The map so provided may be used as an additional quality parameter.

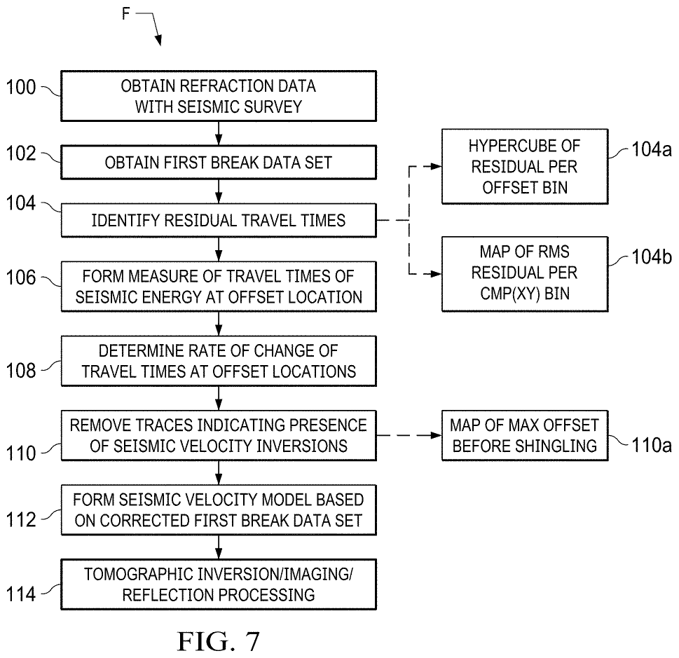

A comprehensive computer implemented methodology of modeling for detection and removal of delayed seismic travel times produced by velocity inversions according to the present invention is illustrated schematically by a workflow or flow chart F in FIG. 7. As will be described, certain portions of the flow chart F illustrate the structure of the logic of the present invention as embodied in computer program software. Those skilled in the art will appreciate that these portions of flow chart F also illustrate functions which may be performed by structures of computer program code elements including logic circuits on an integrated circuit that function according to the present invention. Manifestly, the present invention is practiced in its essential embodiment by a machine component that renders the program code elements in a form that instructs a digital processing apparatus (that is, a data processing system or computer) to perform a sequence of data transformation or processing steps corresponding to those shown.

As are seen from the flow chart F, processing according to the present invention includes obtaining refraction seismic survey data from a seismic survey as indicated generally at 100. During step 102, a first break dataset from the refraction seismic survey data is obtained by processing in the data processing system D (FIG. 10). Steps 100 and 102 are performed according to U.S. Pat. No. 10,067,255, “Automatic Quality Control of Seismic Travel Time” and U. S. Published Application No. 2017/0176617, previously mentioned.

Processing subsequent to step 102 involves performing in the data processing system D, under control of stored computer operable instructions, a sequence of steps to detect and remove effects of the seismic velocity inversions according to the present invention. During step 104, a measure of travel times of the seismic traces of the first break dataset is formed as a function of offset of the detector geophones from the seismic sources.

Step 104 is performed by constrained cubic spline fitting (outputs of hypercube residual and RMS residual map). A constrained cubic spline is fitted to the statistically filtered and averaged travel times in XYO. The monotonically increasing spline has the scope of identifying the misfit with the data travel times.

As has been described in connection with FIG. 6, fitting of shingled events from the seismic survey with a spline during step 104 produces large residuals such as shown at 82 (FIG. 6) between the travel time data to be fitted and the spline. During step 104a according to the present invention, the resultant residuals are used to map the corresponding travel time residual (that is, one residual value per offset) in the XYO bin of the hypercube. The resulting output (a hypercube) permits analysis of the relative residual per offset plane. This allows the identification of the offset most affected by the misfit problem. The identified offset is one where the velocity determination from the spline is the least reliable.

The residuals for each offset bin of an XY (midpoint) position are also used during step 104b to determine an RMS (root mean square) magnitude of travel time misfit value, and thus a map of RMS residuals for each XY position. The RMS map from step 104b provides a summary value of the velocity quality determination. Where the RMS is high it is likely that the obtained velocity is not reliable, and thus of uncertain value. This uncertainty map provides a guide to processors and interpreters.

In a preferred embodiment, a cubic Hermite spline function is used for fitting and interpolating the travel times versus offsets data. However, it should be understood that other forms of computerized fitting are also suitable, and the fitting may be applied by similar types of numerical analysis functions defined piecewise by polynomials.

In numerical analysis, a cubic Hermite spline or cubic Hermite interpolator is a spline where each piece or segment of the fitted function is a third-degree polynomial specified in Hermite form. In Hermite form, both the polynomial defining the values of the travel time as a function of offset, and a first derivative of the travel time function (rate of travel) at each of a number end points in travel time-offset data. The cubic Hermite splines so used during step 104 for interpolation of travel times provide a smooth, continuous spline function. The resulting spline is continuous and exhibits a continuous first derivative.

Fitting a cubic Hermite spline to the input data includes selecting a group of data points at a succession of offset distances:

\hat{x}_{knot,i},1=1,2, . . . ,K and \hat{x}_{knot,i}≤\hat{x}_{knot,i+1}.

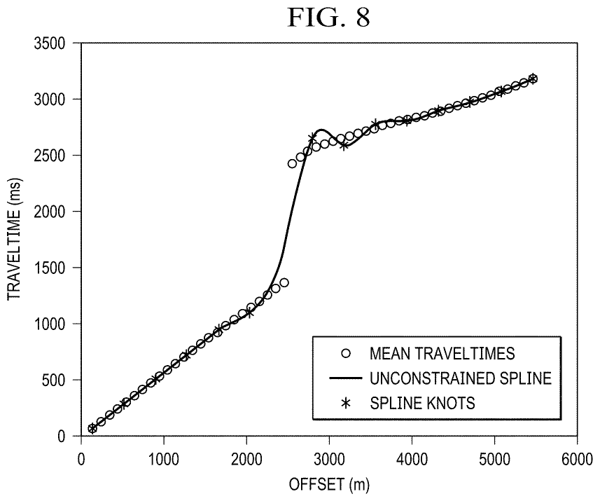

which are known as knots. FIG. 8 is a display of example knots.

For each knot interval

[\hat{x}_{knot,i},\hat{x}_{knot,i+1}]

the spline is defined by the cubic polynomial:

tᵢ(x)=(2pᵢ−2pᵢ₊₁+mᵢ+mᵢ₊₁)x₃+(−3pᵢ+3pᵢ₊₁−2mᵢ−mᵢ₊₁)x²+mᵢx+pᵢ (1)

In processing according to step 106, parameters pᵢ and pᵢ₊₁ are the values of tᵢ(x) at the endpoints of the interval. The parameters mᵢ and mᵢ₊₁ are the values of the first derivative of the polynomial (tᵢ′(x)) at the endpoints. It is to also be noted that x in Equation (1) is defined in normalized unit interval [0, 1] values of offset rather than in thousands of meters.

For an offset \hat{x} in [\hat{x}_{knot,i}, \hat{x}_{knot,i+1}], x and \hat{x} are related by

$$x = \frac{\hat{x} - {\hat{x}}_{knot , i}}{{\hat{x}}_{knot , i + 1} - {\hat{x}}_{knot , i}}$$

During step 106 which follows step 104, a measure of travel time at individual offset locations in the seismic survey is formed in the data processing system D. Step 106 is performed by computerized application of unconstrained cubic spline to the seismic data. The survey data processed during step 106 is the full set of data including traces where the effect of shingling is or may be present. Step 106 is performed to fit into a spline as much as possible of the entire set of data, which includes data with the shingled travel times. By doing this, both the accurate and the shingled travel times can be represented by a continuous smooth function in the formed spline. FIG. 8 is a display as indicated by identifying symbols of an unconstrained spline fitted obtained as a result of step 108 for the travel times versus offset data at a specific x, y, offset common midpoint (CMP) location. Spline knots defined for the processing are also shown in FIG. 8 and identified by symbols.

In processing according to step 108, parameters pᵢ and pᵢ₊₁ are again the values of tᵢ(x) at the endpoints of the interval. The parameters mᵢ and mᵢ₊₁ are the values of the first derivative of the polynomial (tᵢ(x)) at the endpoints. These four parameters are determined by the spline fitting process for each of the knot locations selected. Based on the determined values of these parameters, an analytic expression for the spline derivative can be computed as:

tᵢ′(x)=(6pᵢ−6pᵢ₊₁+3mᵢ+3mᵢ₊₁)x²+(−6pᵢ+6pᵢ₊₁−4mᵢ−2mᵢ₊₁)x+mᵢ (2)

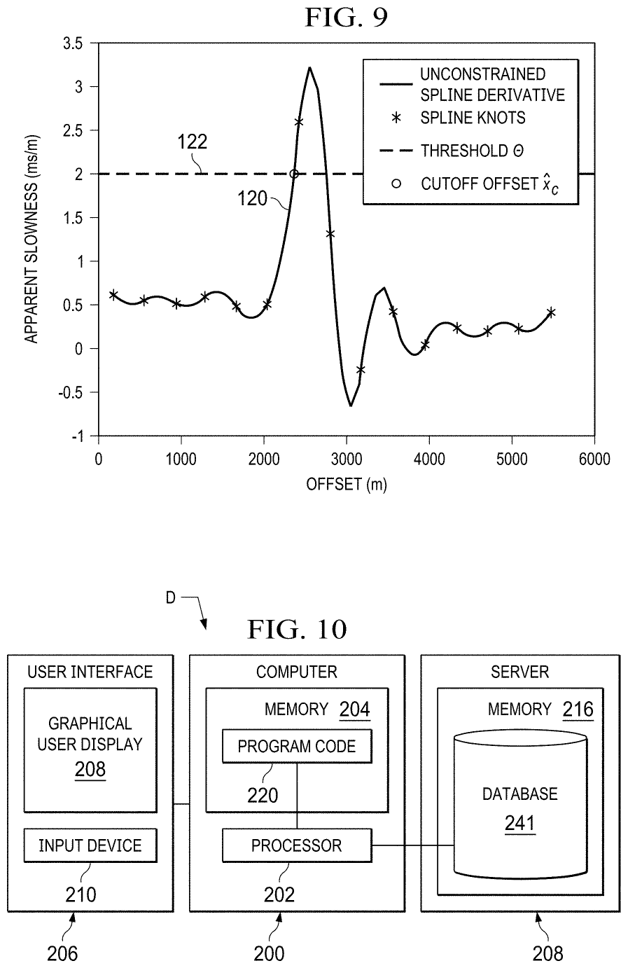

For each knot interval in succession, starting with an initial interval [symbol] _{knot,1}, \hat{x}_{knot,2}], processing according to the present invention tests whether the rate of change or derivative meets a certain threshold (FIG. 9). According to the present invention, the threshold value is selected and defined taking into account the fact that shingling manifests as a steep increase of travel time at the offsets at which it occurs, which implies a large value of the first derivative which represents the fitted rate of change, or apparent slowness, at those offsets.

Step 108 follows step 106 and is performed by computerized determination of a measure of rate of travel of the seismic energy at the individual offset locations. According to the present invention, for ease of processing the rate of travel is measured in terms of apparent slowness, which is the inverse of apparent velocity.

Step 108 thus determines by computer processing a derivative, as will be described, on the smooth spline function determined during step 106. According to the present invention, magnitude of the rate of change of travel distance increases sharply at offset locations where shingled travel times are present. FIG. 9 is an example display of an unconstrained spline derivative 120 according to the present invention and a selected threshold 122.

Processing in the data processing system during step 108 determines whether there exists an offset x∈[0, 1] such that tᵢ′(x)=θ. Or, using (2), whether

(6pᵢ−6pᵢ₊₁+3mᵢ+3mᵢ₊₁)x²+(−6pᵢ+6pᵢ₊₁−4mᵢ−2mᵢ₊₁)x+mᵢ−θ=0 (3)

has real roots in [0, 1]. This is performed by solving a simple quadratic equation of the form:

aᵢx²+bᵢx+cᵢ=0 (4)

with

aᵢ=(6pᵢ−6pᵢ₊₁+3mᵢ+3mᵢ₊₁)

bᵢ=(−6pᵢ+6pᵢ₊₁−4mᵢ−2mᵢ₊₁)

cᵢ=mᵢ−θ (5)

With the aid of a determinant, Δᵢ=bᵢ²−4aᵢcᵢ, there are two candidate solutions, which are:

$${x}_{s , 1} = \frac{- {b}_{i} - \sqrt{{Δ}_{i}}}{2 {a}_{i}} {x}_{s , 2} = \frac{- {b}_{i} + \sqrt{{Δ}_{i}}}{2 {a}_{i}} \qquad ( 6 )$$

Only candidate solutions that are real and in the range [0, 1] are valid. There are four possibilities for the candidate solutions:

(a) The first and second possibilities are that both x_{s,1} and x_{s,2} are valid: a cutoff offset x_{c}=min (x_{s,1}, x_{s,2}) is set. The process stops.

(b) The third possibility is that only one of x_{s,1} and x_{s,2} is valid. Then x_{c}=x_{s,1} or x_{c}=x_{s,2}, accordingly. The process stops.

(c) The fourth possibility is that neither one is a valid solution. The process is then repeated for a next sequential knot interval:

[ [symbol] _{knot,i+1},\hat{x}_{knot,i+2}]

Step 110 is performed in the data processing system D by removing from the first break dataset seismic traces at the individual offset locations indicating the presence of seismic velocity inversions. Performance of step 110 is based on the determined measure of the rate of change of travel distance of the seismic energy to form a corrected first break dataset resulting from step 108.

Step 110 determines by computer processing maximum offset for each CMP location before shingling is present, and is based on the threshold determined during step 108. The threshold magnitude resulting from step 108 identifies an offset where travel times are not affected by shingling. Such an offset represents the offset where the sharp increase occurs, and thus where the shingling begins. As indicated at step 110a, processing according to the present invention may also include forming a map or database of maximum usable offsets which can be reliably used to determine a seismic velocity function. The results of step 110a are then stored and provided as an output display by the data processing system D.

The resulting maximum offset for each CMP location x_{c} is then converted during step 110 from the normalized interval [0, 1] to the interval [\hat{x}_{knot,i}, \hat{x}_{knot,i+1}] using:

x_{c}=x_{c}(x_{knot,i+1}−x_{knot,i})+x_{knot,i}) (7)

If no valid solution was found in any of the knot intervals, \hat{x}_{c} is set to the largest observed offset.

During step 112, the valid travel times not affected by seismic velocity inversions or shingling are flagged and the constrained spline formed as a result of step 104 is run again to fit them into a velocity model with the effect of shingling removed. The velocity model formed during step 112 is thus correct and accurate. The RMS misfit is low and the improvement of the RMS misfit map can be checked between the original dataset and the new dataset with the shingled travel times having been removed.

In step 112, a constrained spline is fitted up to offset \ddot{x}_{c}. The fitted constrained spline is then simplified and inverted for the velocity model during step 114. Step 114 is performed in the data processing system D by tomographic inversion or by another suitable method for obtaining a velocity-depth model from travel time vs offset data. Step 114 involves forming a seismic velocity model of seismic velocity as a function of depth the subsurface formation based on the corrected first break data set. Step 114 also includes forming an image of the subsurface strata by performing a tomographic inversion based on the velocity model resulting from step 112 with the corrected first break dataset. The image formed during step 114 provides a basis for further seismic reflection processing to provide improved detection and development of hydrocarbon resources.

### Data Processing System

As illustrated in FIG. 10, the data processing system D includes a computer 200 having a processor 202 and memory 204 coupled to the processor 202 to store operating instructions, control information and database records therein. The data processing system D may be a multicore processor with nodes such as those from Intel Corporation or Advanced Micro Devices (AMD), an HPC Linux cluster computer or a mainframe computer of any conventional type of suitable processing capacity such as those available from International Business Machines (IBM) of Armonk, N.Y., or other source. The data processing system D may also be a computer of any conventional type of suitable processing capacity, such as a personal computer, laptop computer, or any other suitable processing apparatus. It should thus be understood that a number of commercially available data processing systems and types of computers may be used for this purpose.

The processor 202 is, however, typically in the form of a personal computer having a user interface 206 and an output display 208 for displaying output data or records of processing of seismic survey data according to the present invention. The output display 208 includes components such as a printer and an output display screen capable of providing printed output information or visible displays in the form of graphs, data sheets, graphical images, data plots and the like as output records or images.

The user interface 206 of computer 200 also includes a suitable user input device or input/output control unit 210 to provide a user access to control or access information and database records and operate the computer 200.

Data processing system D further includes a database 214 stored in memory, which may be internal memory 204, or an external, networked, or non-networked memory as indicated at 216 in an associated database server 218. The database 214 also contains various seismic data including the in the form of seismic traces, source and geophone position co-ordinates, survey times and parameters and other data.

The data processing system D includes program code 220 stored in a data storage device, such as memory 204 of the computer 200. The program code 220, according to the present invention is in the form of computer operable instructions causing the data processor 202 to perform the methodology according to the present invention of detection and removal of delayed seismic travel times produced by velocity inversions.

It should be noted that program code 220 may be in the form of microcode, programs, routines, or symbolic computer operable languages that provide a specific set of ordered operations that control the functioning of the data processing system D and direct its operation. The instructions of program code 220 may be stored in non-transitory memory 204 of the computer 200, or on computer diskette, magnetic tape, conventional hard disk drive, electronic read-only memory, optical storage device, or other appropriate data storage device having a computer usable medium stored thereon. Program code 220 may also be contained on a data storage device such as server 208 as a non-transitory computer readable medium, as shown.

The processor 202 of the computer 200 accesses the seismic survey data pressure transient testing data and other input data measurements as described above to perform the logic of the present invention, which may be executed by the processor 202 as a series of computer-executable instructions. The stored computer operable instructions cause the data processor computer 200 to detect and remove delayed seismic travel times produced by velocity inversions in the manner described above and shown in FIG. 10. Seismic tomographic images as result of processing according to the present invention are then available on output display 208.

The present invention is integrated into a practical application. The present invention improves the reliability of seismic images and enhances the ability to discover new hydrocarbon resources. The present invention avoids the technological problems caused by seismic velocity inversions.

The present invention provides robust velocity modeling of complex near surface geology. The present invention provides accurate and representative seismic velocities for the near surface layer. Accurate seismic velocities are provided, and accurate and reliable seismic tomographic images are formed of the subsurface formations of interest for hydrocarbon exploration.

The invention has been sufficiently described so that a person with average knowledge in the field of geophysics and seismic exploration and processing methods may reproduce and obtain the results mentioned herein described for the invention. Nonetheless, any skilled person in the field of technique, subject of the invention herein, may carry out modifications not described in the request herein, to apply these modifications to a determined structure and methodology, or in the use and practice thereof, requires the claimed matter in the following claims; such structures and processes shall be covered within the scope of the invention.

It should be noted and understood that there can be improvements and modifications made of the present invention described in detail above without departing from the spirit or scope of the invention as set forth in the accompanying claims.

What is claimed is:

1. A method of detecting and removing effects of seismic velocity inversions in near surface earth layers from seismic survey data in the form of a set of seismic survey traces obtained from records of seismic energy travel from seismic sources to an array of seismic detector geophones during a seismic survey, the method being performed in a computer comprising a memory and a processor and comprising the computer implemented steps of:
(a) obtaining refraction seismic survey data from the seismic survey;
(b) obtaining a first break dataset from the refraction seismic survey data;
(c) storing in a memory of a data processing system computer operable instructions causing the computer to process the obtained first break data set to detect and remove effects of seismic velocity inversions in near surface earth layers from the seismic survey data;
(d) performing in the processor, under control of the stored computer operable instructions, steps to detect and remove effects of the seismic velocity inversions by performing steps of:
(1) determines a measure of travel times of the seismic traces of the first break dataset as a function of offset of the detector geophones from the seismic sources;
(2) forming a measure of travel time at individual offset locations in the seismic survey;
(3) determining a measure of rate of travel of the seismic energy at the individual offset locations;
(4) removing from the first break dataset seismic traces at the individual offset locations indicating the presence of seismic velocity inversions based on the determined measure of the rate of travel of the seismic energy to form a corrected first break dataset;
(5) forming a seismic velocity model of seismic velocity as a function of depth the subsurface formation based on the corrected first break data set; and
(6) forming an image of the subsurface strata by performing a tomographic inversion on the corrected first break dataset.

2. The method of claim 1, wherein the processor under control of the stored program instructions further performs the step of:
forming a measure of the travel time residuals at the individual offset locations in the seismic survey.

3. The method of claim 2, wherein the processor under control of the stored program instructions further performs the step of:
mapping the formed measure of travel time residuals at the individual offset locations in the seismic survey.

4. The method of claim 1, wherein the processor under control of the stored program instructions further performs the step of:
determining a measure of magnitude of travel time residuals at the individual offset locations in the seismic survey.

5. The method of claim 1, wherein the processor under control of the stored program instructions further performs the step of:
forming a measure of maximum acceptable offsets for seismic velocity modeling.

6. The method of claim 1, wherein the processor under control of the stored program instructions further performs the step of:
performing reflection processing based on the results of the tomographic inversion.

7. A data processing system detecting and removing effects of seismic velocity inversions in near surface earth layers from seismic survey data in the form of a set of seismic survey traces obtained from records of seismic energy travel from seismic sources to an array of seismic detector geophones during a seismic survey, comprising:
a memory storing computer operable instructions causing the data processing system to detect and remove the effects of the seismic velocity inversions in the near surface earth layers from seismic survey data;
a processor performing under control of the computer operable instructions stored in the memory steps of:
(a) determining a measure of travel times of the seismic traces of the first break dataset as a function of offset of the detector geophones from the seismic sources;
(b) forming a measure of travel time at individual offset locations in the seismic survey;
(c) determining a measure of rate of travel of the seismic energy at the individual offset locations;
(d) removing from the first break dataset seismic traces at the individual offset locations indicating the presence of seismic velocity inversions based on the determined measure of the rate of travel of the seismic energy to form a corrected first break dataset;
(e) forming a seismic velocity model of seismic velocity as a function of depth the subsurface formation based on the corrected first break data set;
(f) forming an image of the subsurface strata by performing a tomographic inversion on the corrected first break dataset; and
the memory further receiving for storage the formed model of seismic velocity as a function of depth the subsurface formation based on the corrected first break data set.

8. The data processing system of claim 7, wherein the processor under control of the stored program instructions further performs the step of forming a measure of the travel time residuals at the individual offset locations in the seismic survey.

9. The data processing system of claim 8, wherein the processor under control of the stored program instructions further performs the step of mapping the formed measure of travel time residuals at the individual offset locations in the seismic survey.

10. The data processing system of claim 7, wherein the processor under control of the stored program instructions further performs the step of determining a measure of magnitude of travel time residuals at the individual offset locations in the seismic survey.

11. The data processing system of claim 7, wherein the wherein the processor under control of the stored program instructions further performs the step of forming a measure of maximum acceptable offsets for seismic velocity modeling.

12. The data processing system of claim 9, wherein the processor under control of the stored program instructions further performs the step of performing reflection processing based on the results of the tomographic inversion.

13. A data storage device having stored in a non-transitory computer readable medium computer operable instructions for causing a data processing system comprising a memory and a processor to detect and remove effects of seismic velocity inversions in near surface earth layers from seismic survey data in the form of a set of seismic survey traces obtained from records of seismic energy travel from seismic sources to an array of seismic detector geophones during a seismic survey, the instructions stored in the data storage device causing the data processing system to perform the following steps:
storing in the memory computer operable instructions causing the data processing system to detect and remove effects of seismic velocity inversions in near surface earth layers from seismic survey data;
performing in the processor, under control of the stored computer operable instructions, steps to detect and remove effects of seismic velocity inversions in near surface earth layers, comprising:
(a) determining a measure of travel times of the seismic traces of the first break dataset as a function of offset of the detector geophones from the seismic sources:
(b) forming a measure of travel time at individual offset locations in the seismic survey;
(c) determining a measure of rate of travel of the seismic energy at the individual offset locations;
(d) removing from the first break dataset seismic traces at the individual offset locations indicating the presence of seismic velocity inversions based on the determined measure of the rate of travel of the seismic energy to form a corrected first break dataset;
(e) forming a seismic velocity model of seismic velocity as a function of depth the subsurface formation based on the corrected first break data set; and
(f) forming an image of the subsurface strata by performing a tomographic inversion on the corrected first break dataset.

14. The data storage device of claim 13, wherein the instructions further include instructions for forming a measure of the travel time residuals at the individual offset locations in the seismic survey.

15. The data storage device of claim 14, wherein the instructions further include instructions for mapping the formed measure of travel time residuals at the individual offset locations in the seismic survey.

16. The data storage device of claim 13, wherein the instructions further include instructions for determining a measure of magnitude of travel time residuals at the individual offset locations in the seismic survey.

17. The data storage device of claim 13, wherein the instructions further include instructions for forming a measure of maximum acceptable offsets for seismic velocity modeling.

18. The data storage device of claim 13, wherein the instructions further include instructions for performing reflection processing based on the results of the tomographic inversion.
